(19) United States
(12) Patent Application Publication
(10) Pub. No.: US 2005/0207490 A1
(43) Pub. Date: Sep. 22, 2005

(54) Stored picture index for AVC coding

(76) Inventors: Jason N. Wang, San Jose, CA (US); Milan Mehta, Newark, CA (US)

Correspondence Address: Sheryl Sue Holloway;BLAKELY, SOKOLOFF, TAYLOR & ZAFMAN LLP, Seventh Floor, 12400 Wilshire Boulevard, Los Angeles, CA, 90025, US

(21) Appl. No.: 11/078,763

(22) Filed: Mar. 11, 2005

Related U.S. Application Data
(60) Provisional application No. 60/554,529, filed on Mar. 18, 2004.

(51) Int. Cl. H04N 7/12

(52) U.S. Cl. 375/240.15; 375/240.12; 375/240.25; 375/240.24

(57) ABSTRACT

A new identifier, called the active ID, is computed for each decoded video picture used as a reference picture. The active ID is computed from the frame buffer index and the frame-field encoding type and uniquely identifies each of the decoded video pictures. In one aspect, the active ID identifies decoded video pictures used in a B direct co-located macroblock prediction process. In another aspect, the active ID identifies decoded video pictures used in a de-blocking process.

### RELATED APPLICATIONS

This application claims the benefit of U.S. Provisional Application 60/554,529 filed Mar. 18, 2004, which is hereby incorporated by reference.

### FIELD OF THE INVENTION

This invention relates generally to video encoding and decoding, and more particularly to H.264 Advanced Video Coding.

### COPYRIGHT NOTICE/PERMISSION

A portion of the disclosure of this patent document contains material which is subject to copyright protection. The copyright owner has no objection to the facsimile reproduction by anyone of the patent document or the patent disclosure as it appears in the Patent and Trademark Office patent file or records, but otherwise reserves all copyright rights whatsoever. The following notice applies to the software and data as described below and in the drawings hereto: Copyright © 2003, Sony Electronics, Incorporated, All Rights Reserved.

### BACKGROUND OF THE INVENTION

H.264 Advanced Video Coding (AVC) is a ITU-T Video Coding Experts Group and ISO Motion Picture Expert Group (MPEG) standard for low bitrate visual communications (“Draft of ITU-T Recommendation and Final Draft International Standard of Joint Specification”, ITU-T Rec. H.264 ISO/IEC 14496-10 AVC, JVT-N6359, March 2004) (hereinafter referred to as “AVC Standard”). AVC supports several different coding types. The simplest is intra encoding (I), where a video picture is encoded without referring to other pictures in the video sequence. In contrast, inter encoding types, such as predictive (P) and bi-predictive (B) encoding, use other prior-encoded pictures to encode the video picture. Each picture is sub-divided into blocks. Groups of blocks from the same picture are further organized into slices. Each slice is independently encoded.

A P-slice uses inter prediction from previously decoded reference pictures with at most one motion vector to predict the pixel values of the block. A motion vector provides an offset from the block coordinates in the decoded picture to block coordinates in a reference picture. The reference pictures used for P-slice block prediction are stored in multi-picture buffer (list 0) with each reference picture having its own reference ID.

In contrast with P-slice encoding, blocks in B-slice encoding use a weighted average of two distinct motion-compensation values for building the motion vector. B-slices use two distinct reference picture buffers, list 0 and list 1. For B-slices, four different types of inter-picture prediction modes are supported: list 0, list 1, bi-predictive, direct spatial and direct temporal. B temporal direct mode prediction mode does not generate a motion vector in the encoding process, but instead derives the motion vector by scaling the motion vector of the co-located block in the reference picture. Furthermore, the reference picture for the current block is the same as for the co-located block. Motion vector scaling is performed according to the temporal distances among the current picture, the picture containing the co-located block and the reference picture of that block. References to B direct prediction below are taken to mean B temporal direct mode predictions.

In B direct prediction mode, the decoder determines if two blocks use the same reference pictures. The AVC standard refers to the reference pictures as “stored pictures” because the reference pictures are stored in a buffer (also referred to as a “frame buffer”). In the AVC standard, there are three schemes to identify a stored picture. In one scheme, each stored picture has a reference ID, which is used to index the stored pictures in a list of reference pictures. Because the maximum range of frame reference ID is less than or equal to 32, it is possible to create simple look up tables for reference IDs. However, a reference ID is only unique within an associated reference list, as different slices may use different reference lists. In another scheme, each stored picture has a frame and picture number. The encoder assigns the frame number, whereas the picture number is derived from the frame number and the current encoded picture frame-field mode. Because, the picture number is derived in part from the frame-field mode, the picture number is unique for any stored picture. In contrast, the frame number is unique only for any stored frame, as two stored field pictures can share the same frame number. Furthermore, because the maximum frame and picture numbers are 2¹⁶−1 and 2¹⁷, respectively, it is difficult to build a simple look up table based on the picture or frame number. In a third scheme, each stored picture has a picture order count (POC). While each frame has a unique POC, two fields may share the same POC. Because the POC range is 2³², it is difficult to use POC in simple look up table. Thus, only the picture number uniquely identifies a picture, but is not suitable for a simple look-up table. None of the other current AVC identifiers both uniquely identify a picture and are suitable for a simple lookup table.

Furthermore, the AVC standard supports vertical macroblock pairs that can alternately be frame or field encoded within the same slice, called MacroBlock Adaptive Frame Field (MBAFF) coding. For MBAFF, a field reference picture may be used, but the field picture number is not defined when the current picture is coded as MBAFF frame. Then, the picture number combined with the field type indexes each reference field, further increasing the complexity of the decoder.

### SUMMARY OF THE INVENTION

A new identifier, called the active ID, is computed for each decoded video picture used as a reference picture. The active ID is computed from the frame buffer index and the frame-field encoding type and uniquely identifies each of the decoded video pictures. In one aspect, the active ID identifies decoded video pictures used in a B direct co-located macroblock prediction process. In another aspect, the active ID identifies decoded video pictures used in a de-blocking process.

The present invention is described in conjunction with systems, clients, servers, methods, and machine-readable media of varying scope. In addition to the aspects of the present invention described in this summary, further aspects of the invention will become apparent by reference to the drawings and by reading the detailed description that follows.

### BRIEF DESCRIPTION OF THE DRAWINGS

The present invention is illustrated by way of example and not limitation in the figures of the accompanying drawings in which like references indicate similar elements.

FIG. 1 illustrates one embodiment of the AVC encoding/decoding system.

FIG. 2 is a flow diagram of one embodiment of a method to compute the active ID of a decoded video picture.

FIG. 3 illustrates one embodiment to retrieve the B-direct prediction motion vectors and reference ID.

FIG. 4A, 4B are flow diagrams of one embodiment of a method that uses the active ID in the B direct co-located block prediction process.

FIG. 5 is a flow diagram of one embodiment of a method to set long-term frame count.

FIG. 6 is a flow diagram of one embodiment of a method to update long-term frame count for each new frame number.

FIG. 7 is a flow diagram of one embodiment of a method to check if the active ID is reused when there is no long-term reference.

FIG. 8 is a flow diagram of one embodiment of a method to check if the active ID is reused when the co-located picture is a long-term reference picture.

FIG. 9 is a flow diagram of one embodiment of a method to check if the active ID is reused when the reference picture is a long-term reference picture.

FIG. 10 is a flow diagram of one embodiment of a method to check if the active ID is reused when both the co-located picture and reference picture are long-term reference pictures.

FIG. 11 illustrates one embodiment of adjacent blocks in the de-blocking process.

FIG. 12 is a flow diagram of one embodiment of a method using reference picture active IDs in the de-blocking process.

FIG. 13 is a diagram of one embodiment of an operating environment suitable for practicing the present invention.

FIG. 14 a diagram of one embodiment of a computer system suitable for use in the operating environment of FIG. 1.

### DETAILED DESCRIPTION

In the following detailed description of embodiments of the invention, reference is made to the accompanying drawings in which like references indicate similar elements, and in which is shown by way of illustration specific embodiments in which the invention may be practiced. These embodiments are described in sufficient detail to enable those skilled in the art to practice the invention, and it is to be understood that other embodiments may be utilized and that logical, mechanical, electrical, functional, and other changes may be made without departing from the scope of the present invention. The following detailed description is, therefore, not to be taken in a limiting sense, and the scope of the present invention is defined only by the appended claims.

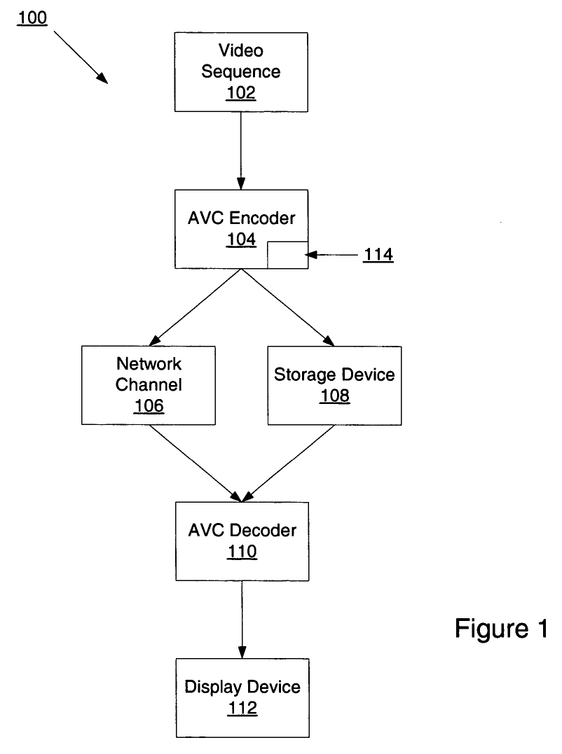

FIG. 1 is a block diagram of one embodiment of an AVC encoding/decoding system 100 that incorporates an active ID to uniquely identify decoded video frames that are used as reference pictures. An AVC decoder 110 generates the active ID when decoding an encoded video bitstream previously generated by an AVC encoder 104 from a video sequence 102. The video sequence 102 may be from a video camera, broadcast TV station, satellite feed station, cable TV headend, or similar. Optionally, the AVC encoder 104 may incorporate a decoder 114 (shown in phantom) that generates the active ID to decode newly encoded pictures into reference pictures for further encoding. It will be appreciated that AVC decoders 110, 114 may be special purpose build hardware, a hardware or firmware component for incorporation into a general purpose system, or software for execution by a processor.

The AVC encoder 104 compresses and encodes the video sequence 102 by partitioning the video sequence 102 into subunits. The video stream 102 is composed of a series of video frames, typically 30 video frames per second. A video frame is composed of a top and a bottom field, and may be classified as either interleaved or progressive based on the arrangement of the alternating rows of the fields within a time period. The AVC standard supports top and bottom fields encoded separately or together as one frame. In one embodiment, the AVC encoder 104 separately encodes fields for interleaved frames while in another embodiment the AVC encoder 104 uses frame encoding for progressive frames. The term “picture” is used herein to refer to either a frame or field. Each picture is further sub-divided into one or more macroblocks, with each macroblock further divided into one or more levels of blocks. Encoding can be applied at the macroblock, sub-block, or smaller block level. The term “block” is used herein to refer to any level block. Macroblocks are further organized into slices, which represent subsets of a given picture that can be decoded independently. An “information unit of correlated data” is defined herein to be a picture, block or slice.

In one embodiment, a network channel 106 transports the video bitstream to the AVC decoder 110, which decompresses and decodes the video bitstream for use by a display 112. The network channel 106 may be a local area network (LAN) or a wide-area network using a communications protocol such as ATM or Ethernet. Alternatively, the network channel 106 may be a satellite feed or a cable TV system. In another embodiment, the resulting video bitstream is stored in storage device 108 for subsequent transmission. The storage device 108 may be any type of machine readable media, such as a fixed disk or removable media.

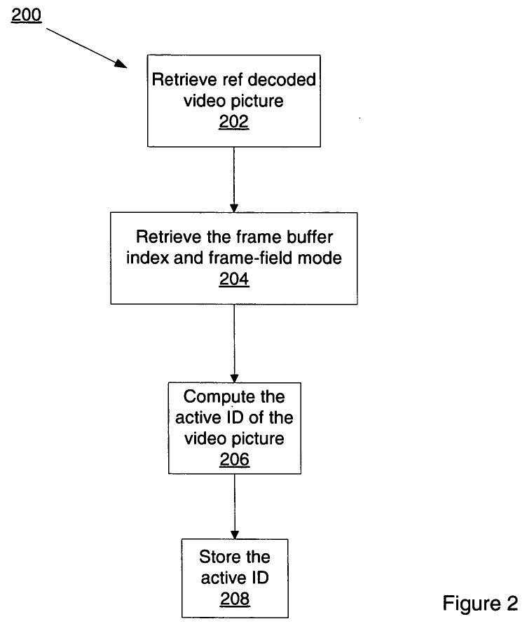

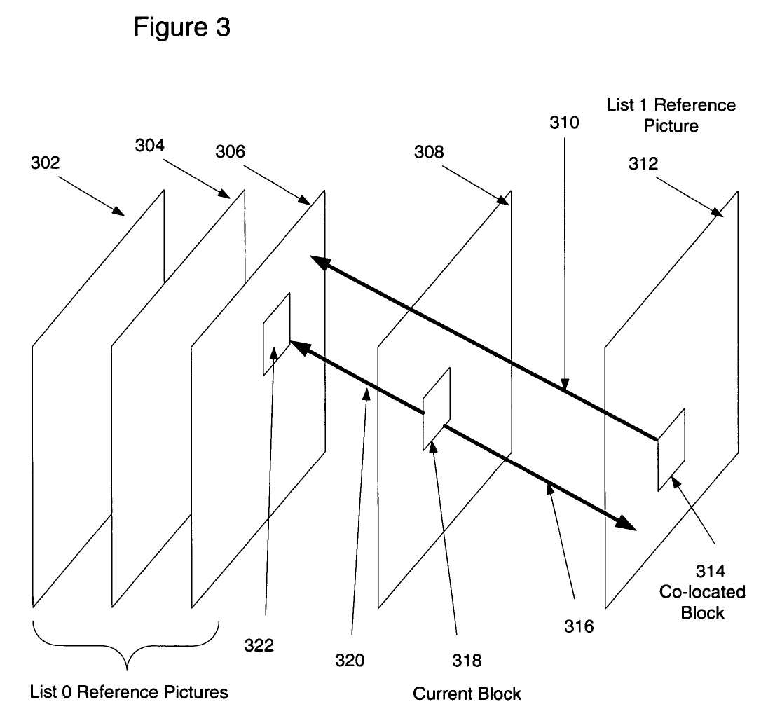

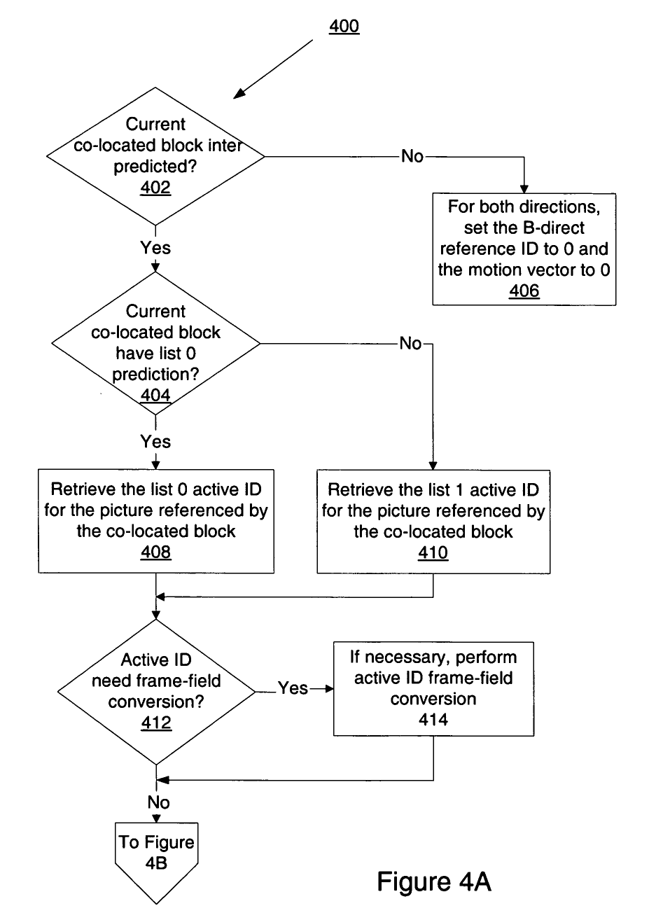

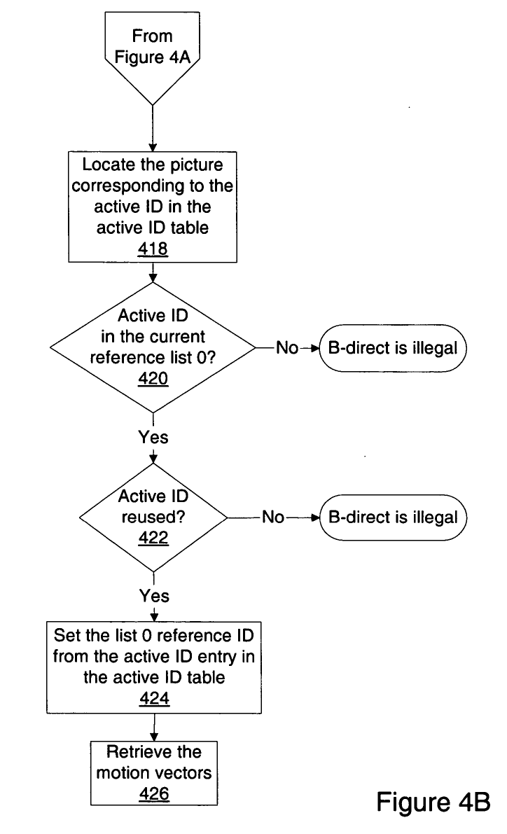

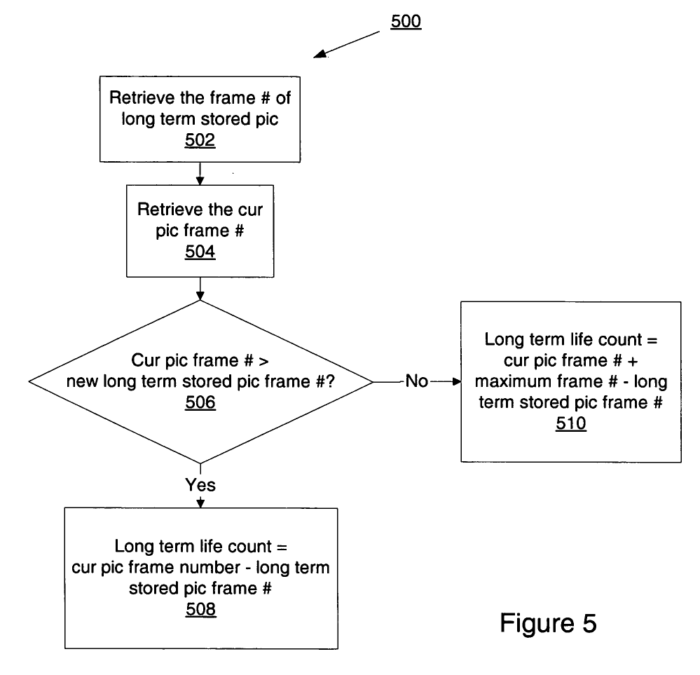

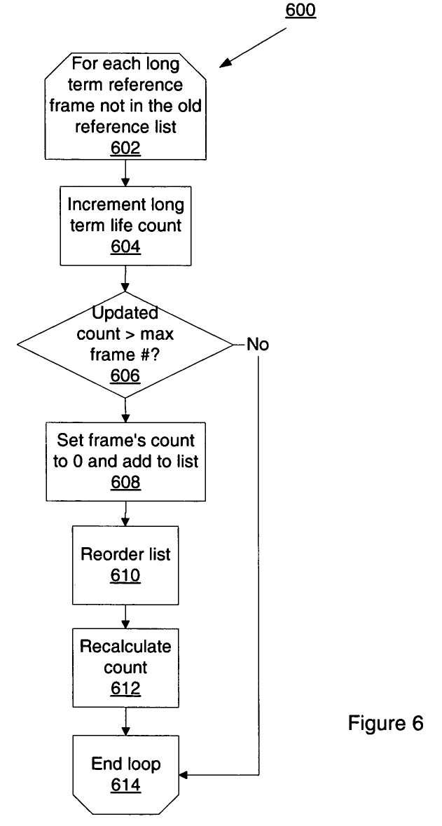

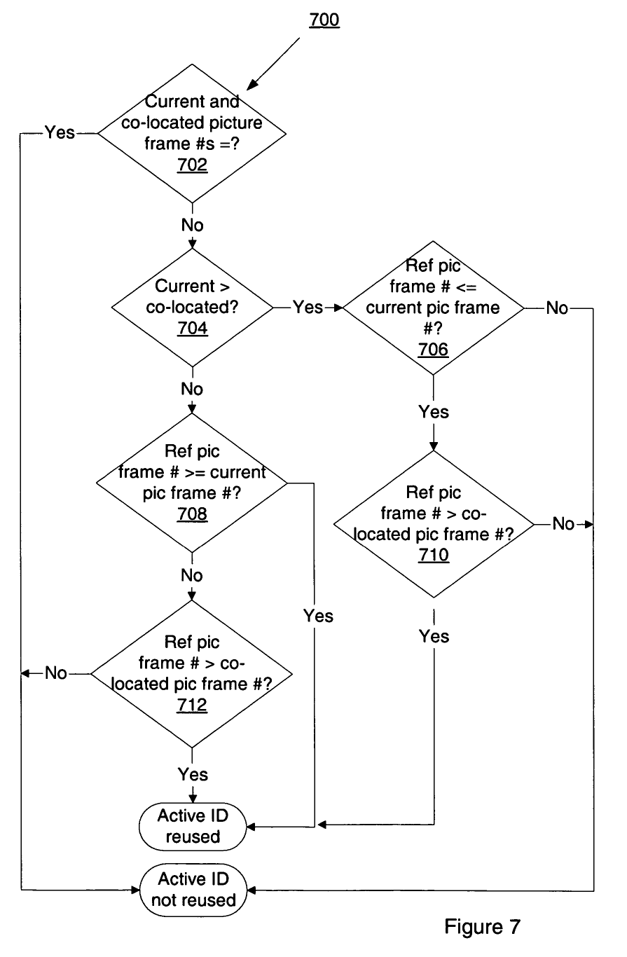

FIGS. 2, 4-11 and 13 illustrate embodiments of methods performed by the decoders 110, 114 of FIG. 1. FIG. 2 illustrates one embodiment of a method 200 to generate the active ID that is used to uniquely identify pictures stored in the frame buffer. FIGS. 4A, 4B are flow diagrams of one embodiment of a method 400 that use the active ID in the B direct prediction process. FIG. 3 illustrates the reference pictures and motion vectors used in method 400. FIGS. 5 and 6 are flow diagrams illustrating methods to set and update the long-term life count, respectively. Different embodiments of active ID reuse are illustrated in FIGS. 7-10.

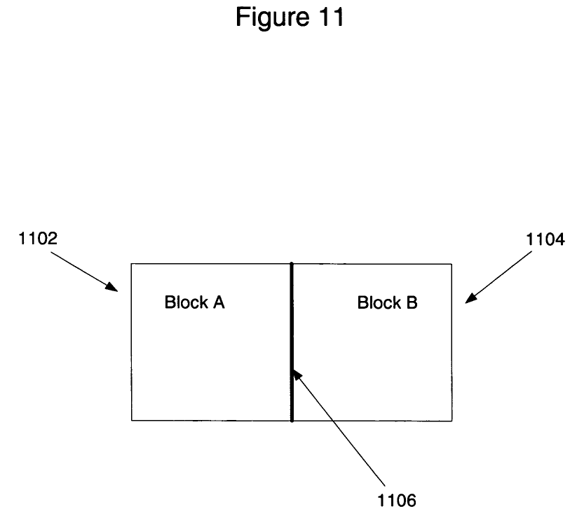

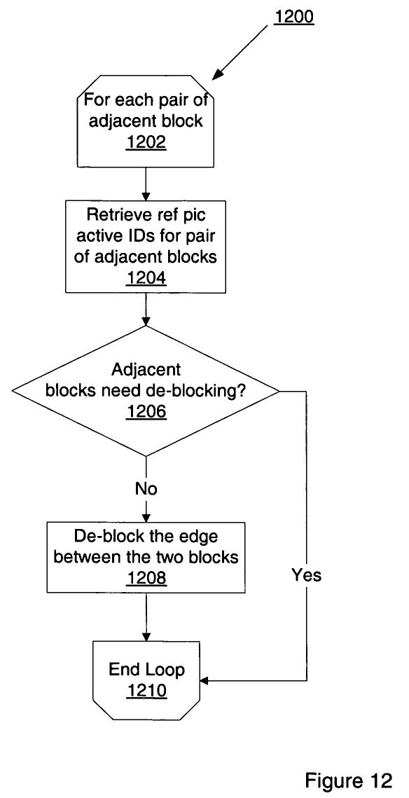

The active ID is additionally used in the de-blocking process. FIG. 11 two adjacent blocks used in de-blocking, while FIG. 12 is a flow diagram illustrating using the active IDs in the de-blocking process.

FIG. 2 is a flow diagram of one embodiment of a method 200 that computes the active ID of a decoded video picture. In one embodiment, the active ID identifies pictures used in the B direct prediction process. In another embodiment, the active ID identifies pictures used in the de-blocking process. The method 200 retrieves a reference decoded video picture (block 202), the picture frame buffer index and frame-field mode (block 204). The frame buffer index is the index of the picture in the decoded frame buffer.

At block 206, the method 200 computes the active ID for the decoded video picture. Three types of active IDs may be computed because a picture can be a frame, top field or bottom field. In one embodiment of block 206, the active ID is computed based on the AVC standard for the maximum size of decoded frame buffer (16). Like above, the active ID equal to the frame buffer index for a given frame. For the top field in the frame, the active ID is equal to the frame buffer index+16. For the bottom field in the frame, the active ID is equal to the frame buffer index+32. Thus, the frame-field mode can be retrieved from an active ID.

Alternatively, the active ID is computed based on the number of pictures in the frame buffer. Thus, for a given frame, the active ID is equal to the frame buffer index. For the top field in the frame, the active ID is equal to twice the frame buffer index. For the bottom field in the frame, the active ID is equal to twice the frame buffer index plus one. However, by computing the active ID based on the number of frames, the picture frame-field mode cannot be retrieved from the active ID.

Because of the active ID definition, at every instant, each frame or field has a unique active ID value. Consequently, comparing reference picture active ID values for two motion vectors determines whether the two reference pictures are the same. Therefore, the reference picture active ID replaces AVC standard reference picture “picture number” and makes it unnecessary to store the picture number for each motion vector. Furthermore, the active ID definition allows for the construction of a simple look-up table, as illustrated below. An active ID based look up table only takes a small piece of memory, because the AVC standard maximum size of a decoded frame buffer is 16. In contrast, a look-up table based on the picture number is unfeasible due to the large range in picture number (2³²).

The active ID is stored at block 208. In one embodiment of block 208, two types of look up tables are used to store the active ID along with other information about each reference picture. One is the reference ID table (Table 1), which contains the reference ID and active ID of the reference picture and is indexed by the reference ID. The other table is the active ID table (Table 2), which contains the active ID, reference ID, frame number and whether the active ID is the current reference list and the active ID is reused. This embodiment determines whether the active ID is reused every time a picture is stored. Alternatively, the determination of active ID reuse is calculated on a block-by-block basis. Furthermore, the active ID table contains information about whether the frame is a long-term picture reference. The active ID indexes the active ID table. In this embodiment, one reference ID and active ID table are generated.

TABLE 1
Reference ID Table

| Reference | |
|---|---|
| ID | Active ID |
| 0 | 5 |
| 1 | 6 |
| 2 | 0 |
| 3 | 1 |

TABLE 2
Frame Active ID Table for frames only.

| | Is in | | | Is long- | Long- | | |
|---|---|---|---|---|---|---|---|
| | current | | | term | term | Is in old | Is the |
| Active | reference | Reference | Frame | reference | life | reference | active ID |
| ID | list | ID | Number | picture? | count | list? | is reused? |
| 0 | Yes | 2 | 100 | No | N/A | No | No |
| 1 | Yes | 3 | 101 | No | N/A | No | No |
| 2 | No | N/A | N/A | No | N/A | No | N/A |
| 3 | No | N/A | N/A | No | N/A | No | N/A |
| 4 | No | N/A | N/A | No | N/A | No | N/A |
| 5 | Yes | 0 | 98 | No | N/A | No | No |
| . | | | | | | | |
| . | | | | | | | |
| . | | | | | | | |
| 15 | Yes | 1 | 99 | No | N/A | No | No |

In another embodiment of block 208, the same two types of tables are used to track top and bottom fields. The reference ID table has the same structure and entries as above. However, the active ID table contains entries for each frame, top field and bottom field (Table 3). Otherwise, the active ID structure is the same for frame and field encoding. In the embodiment illustrated in Table 3, the active ID is computed based on the maximum size of the picture buffer (16). Another embodiment calculates the active ID based on the frame buffer index.

TABLE 3
Field Active ID Table.

| | Is in | | | Is long- | Long- | | Is the |
|---|---|---|---|---|---|---|---|
| | current | | | term | term | Is in old | active |
| | reference | Reference | Frame | reference | life | reference | ID is |
| Active ID | list | ID | Number | picture? | count | list? | reused? |
| 0 | Yes | 2 | 100 | No | N/A | No | No |
| 1 | Yes | 3 | 100 | No | N/A | No | No |
| 2 | No | N/A | N/A | No | N/A | No | N/A |
| 3 | No | N/A | N/A | No | N/A | No | N/A |
| 4 | No | N/A | N/A | No | N/A | No | N/A |
| 5 | Yes | 0 | 98 | No | N/A | No | No |
| 6 | Yes | 1 | 98 | No | N/A | No | No |
| . | | | | | | | |
| . | | | | | | | |
| . | | | | | | | |
| 15 | Yes | 4 | 101 | No | N/A | No | No |
| 16 | Yes | 6 | 100 | No | N/A | No | No |
| 17 | Yes | 7 | 102 | No | N/A | No | No |
| 18 | No | N/A | N/A | No | N/A | No | N/A |
| 19 | No | N/A | N/A | No | N/A | No | N/A |
| 20 | No | N/A | N/A | No | N/A | No | N/A |
| 21 | Yes | 5 | 103 | No | N/A | No | No |
| 22 | Yes | 8 | 103 | No | N/A | No | No |
| . | | | | | | | |
| . | | | | | | | |
| . | | | | | | | |
| 31 | Yes | 2 | 100 | No | N/A | No | No |

In another embodiment of block 208, if a B slice is coded as MBAFF, there are six different reference lists (two for frame macroblock, two for top field macroblock and two for bottom field macroblock) resulting in six reference ID tables and six active ID tables.

Overall, for each encoded block in this process, the method 400 retrieves the active ID for each reference picture used by the motion vector and saves the reference picture active ID with the motion vector. This embodiment of method 400 uses reference ID and active ID tables to identify reference pictures.

FIG. 3 illustrates the reference pictures and motion vectors used in method 400. Pictures 302, 304 and 306 are the list 0 reference pictures. Picture 308 contains the current block 318 and picture 312 is a list 1 reference picture that contains the co-located block 314. Motion vectors 310 and 320 are used to predict block 322. However, motion vector 310 is not generated during the encoding process; instead it is derived from motion vectors 316 and 320.

The method 400 determines at block 402 if the co-located block 314 is inter predicted (i.e. based on motion from other blocks). If not, the method 400 sets the B-direct reference ID and motion vector to 0 in both directions at block 406. If the macroblock is inter predicted, the method 400 determines at block 404 if the co-located block 314 has list 0 prediction. If so, at block 408, the method 400 retrieves the list 0 reference picture active ID for the co-located block 314. Because the co-located picture 306 is the first picture in list 1, the active ID of the co-located picture is found in the first entry of the reference list 1 reference ID table. The method 400 uses the active ID table to determine the frame number of the co-located picture 312. In one embodiment, the process illustrated by block 408 is performed during the current picture decoding. Because field blocks use a field reference list, the co-located picture active ID for a field block is a field active ID. Similarly, the co-located picture active ID for frame blocks is a frame active ID. Thus, the co-located picture active ID needs no frame-field conversion. Furthermore, the co-located block reference picture active ID determines the frame number of co-located block reference picture.

Referring back to block 404, if the current co-located block 314 does not have list 0 prediction, at block 410, the method 400 retrieves the co-located block list 1 active ID.

At block 412, the method 400 determines if the co-located reference picture active ID requires a frame-filed conversion. If the co-located block 314 and the current block 318 are both frame encoded or both field encoded, no conversion is necessary. At block 414, if the current block 318 is frame encoded and the co-located block 314 is field encoded, the co-located reference picture active ID is a field active ID. The field active ID is converted into a frame active ID by setting the frame active ID to field active ID/2. Conversely, if the current block 318 is field encoded and the co-located block 314 is frame encoded, then the co-located reference picture active ID is a frame active ID. The frame active ID is converted into a field active ID. If the current block 318 is in top field, the field active ID is set equal to the frame active ID*2. If the current block 318 is in bottom field, field active ID is set equal to the frame active ID*2+1. After the frame-field conversion, the resultant active ID has the same frame-field mode as the current block 318. The resultant ID is used to look up the reference list 0 for the current block 318 in the active ID table.

The method 400 continues in FIG. 4B. At block 418, the retrieved active ID is used in the active ID table lookup. The method 400 determines at block 420 if the active ID is in the current reference list 0. If not, method 400 ends because the B direct prediction fails. If the active ID is in reference list 0, the method 400 checks at block 422 if the active ID is reused. The methods used to determine active ID reuse are described with reference to FIGS. 7-10 below. If the active ID is reused, the method 400 ends because the B direct prediction fails. Active ID reuse ends the method 400 because the active ID is no longer unique. Finally, if the active ID is not reused, at block 424, the method 400 sets the list 0 reference ID from values contained in the active ID table. At block 426, the method 400 retrieves the motion vectors.

As described above in conjunction with FIG. 4B at block 422, part of the process for B direct prediction is checking if the active ID is reused. The active ID reuse checking process is different when all of the pictures are short-term reference pictures than when some of the reference pictures are long-term reference pictures. A short-term reference is a reference picture that is within the buffer size of the current picture. On the other hand, a long-term reference is a reference picture that is temporally distance, for example, 100 pictures distant in time from the current picture.

FIG. 5 is a flow diagram of embodiment of a method 500 to set the long-term life count. The long-term life count is computed for each long-term reference picture from the frame number difference between the current picture and the long-term picture. The long-term life count is used to determine which long-term reference is temporally more distant. Furthermore, the long-term life count is used in determining if the active ID is reused, as illustrated in FIG. 4B at block 422. The method 500 retrieves the long-term picture frame number (block 502) and the frame current picture number (block 504). At block 506, the method determines whether current picture frame number is greater than new long-term stored picture frame number. If so, at block 508, the long-term life count is set to the difference of the current picture frame number and reference picture frame number. If not, the frame number of a picture between the current and reference pictures has exceeded the frame number maximum value causing the frame number to wrap. Thus, at block 510, the long-term life count is set to current picture frame number plus the frame number maximum value minus reference picture frame number.

All long-term life counts are updated when a new frame number is received from the input video bitstream. FIG. 6 is a flow diagram of one embodiment of a method 600 to update the long-term life counts for each long-term reference picture. The method 600 comprises a processing loop of blocks 602-614. At block 604, the method 600 increments the long-term life count for each long-term reference picture not in the old reference list. Each long-term life count is incremented by the difference between the new frame number and the previous frame number used to determine the long-term life count. The method 600 determines if the long-term life count for a long-term reference picture is equal to the maximum frame number at block 606. If so, at block 608, the frame's long-term life count is set to 0 and the frame is added to the old long-term reference list. At block 610, the old term reference list is re-ordered so that the frame with the larger long-term life count has the larger old reference index. In should be noted that the old reference list uses the long-term life count to determine which long-term reference picture is older and not for determining the time distance between a long-term reference picture and the current picture. At block 612, the long-term life count for the frame is incremented by one and the method 600 for that picture ends. Blocks 602-614 are repeated for each long-term reference picture.

FIG. 7 is a flow diagram of one embodiment of an active ID reuse checking method 700 when the current picture, reference picture and the co-located picture are short-term reference pictures. At block 702, the method 700 determines if current picture frame number is equal to the co-located picture frame number. If so, the active ID is not reused. If not, the method 700 determines if current picture frame number is greater than the co-located picture frame number at block 704. If so, the method 700 determines if the reference picture frame number is less than or equal to current picture frame number. If not, the active ID is not reused. Otherwise, the method 700 determines if the reference picture frame number is greater than co-located picture frame number at block 710. If so, the active ID is reused, else, the active ID is not reused.

Referring back to block 704, if the current picture frame number is less than co-located picture frame number, at block 708, the method 700 determines if reference picture frame number greater than or equal to current picture frame number. If so, the active ID is reused. Otherwise, the method 700 determines if the reference picture frame number is greater than the co-located picture frame number at block 712. If the reference frame number is larger, the active ID is reused. Otherwise, the active ID is not reused.

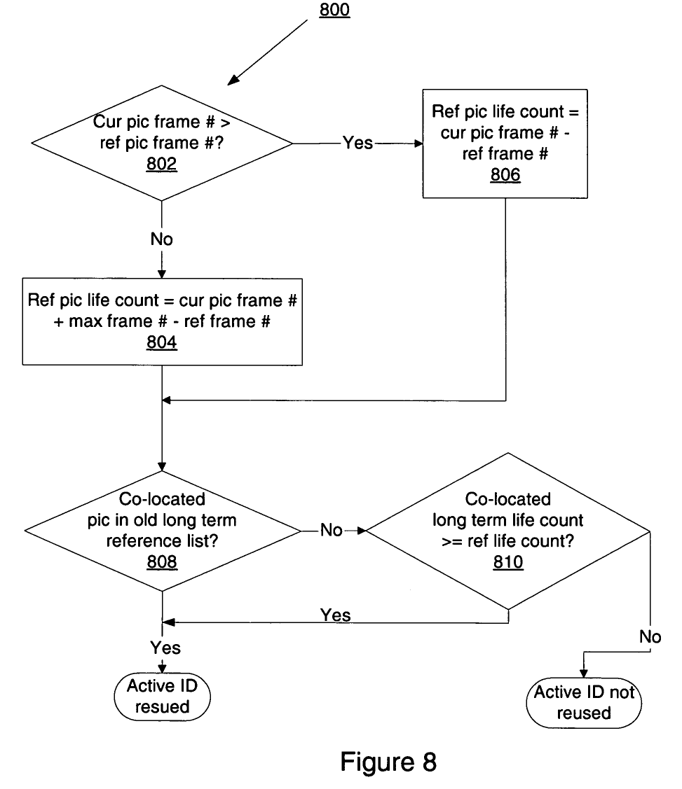

FIG. 8 is a flow diagram of one embodiment of an active ID reuse checking method 800 when the co-located picture is a long-term reference picture. Unlike method 703 that compares the frames numbers of the three pictures involved, the embodiment in method 800 uses the co-located picture long-term life count (as created and updated in FIGS. 5, 6 respectively) as well as the current and reference picture number. At block 802, the method 800 determines if current picture frame number is greater than or equal to reference picture frame number. If so, the method 800 updates the reference picture life count by the difference between current picture frame number and reference picture frame number at block 806. Otherwise, the method 800 updates reference picture life count by current picture frame number plus the frame number maximum value minus reference picture frame number at block 804. The method 800 determines at block 808 if the co-located picture is in the old long-term reference pictures list. If it is, the active ID is reused. Otherwise, at block 810, the method 800 determines if co-located picture long-term life count is larger than or equal to reference picture life count. If so, the active ID is reused. If the co-located picture life count is smaller than the reference picture count, the active ID is not reused.

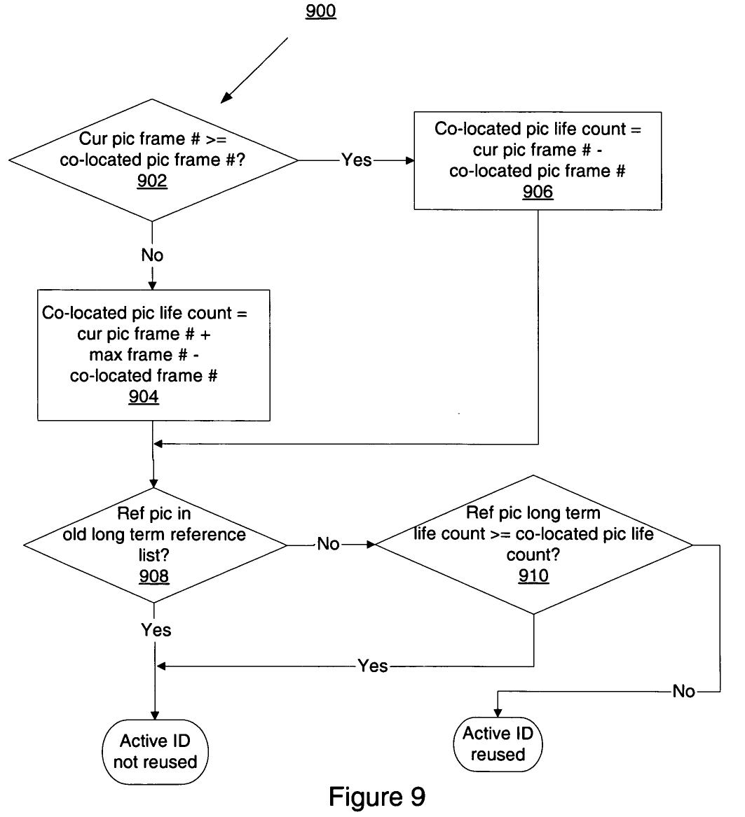

FIG. 9 is a flow diagram of one embodiment of an active ID reuse checking method 900 when the reference picture is a long-term reference picture. At block 902, the method 900 determines if current picture frame number is greater than or equal to co-located picture frame number. If so, the method 900 updates the co-located picture life count by the difference between current picture frame number and co-located picture frame number at block 906. Otherwise, the method 900 updates co-located picture life count at block 904, by current picture frame number plus the frame number maximum value minus co-located picture frame number. The method 900 determines at block 908 if the reference picture is in the old long-term reference pictures list. If it is, the active ID is not reused. If the reference picture is not in the old long-term reference picture list, at block 910, the method 900 determines if reference picture long-term life count is larger than or equal to co-located picture life count. If so, the active ID is not reused, else, the active ID is reused.

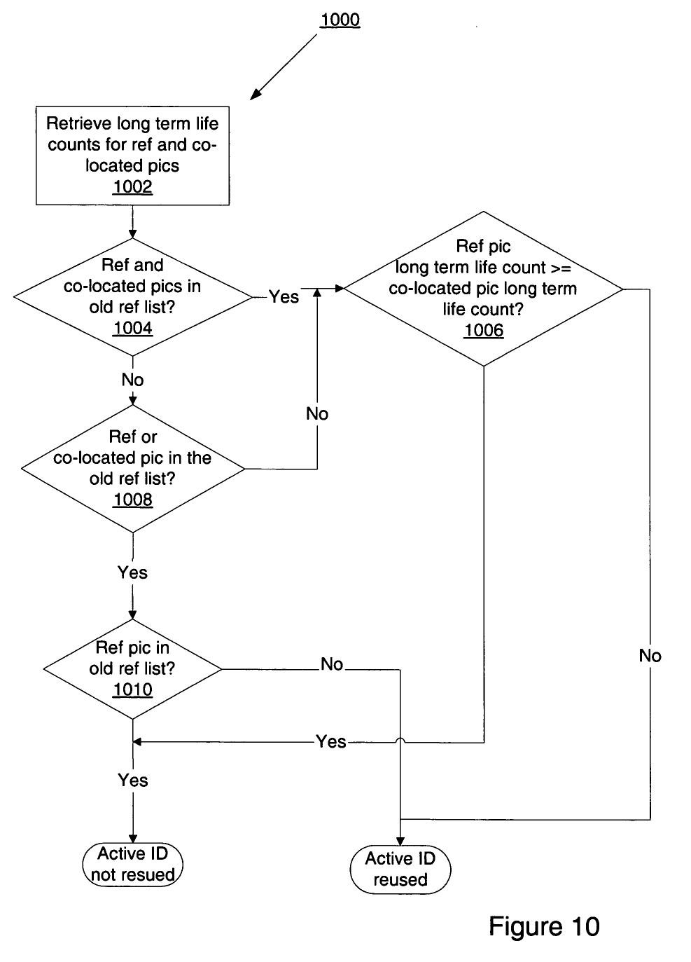

FIG. 10 is a flow diagram of one embodiment of an active ID reuse checking method 1000 when both the co-located picture and reference picture are long-term reference pictures. At block 1002, the method 1000 retrieves the co-located picture long-term life count and reference picture long-term life count. At block 1004, the method 1000 checks if the reference picture and co-located pictured are in the old reference list. If not, at block 1008, the method 1000 checks if either picture is in the old reference list. If so, at block 1010, the method 1000 checks if only the reference picture is on the old reference list. If so, the active ID is not reused. However, if the check at block 1010 fails, the active ID is reused.

Referring back to block 1004, if both the reference and co-located pictures are in the old reference list, the method 1000 checks if the reference picture long-term life count is greater than or equal to co-located picture long-term life count at block 1006. If so, the active ID is not reused. Otherwise, the active ID is reused.

Referring to block 1008, if the reference and co-located pictures are not in the old reference list, the method 1000 checks at block 1006 if the reference picture long-term life count is greater than or equal to co-located picture long-term life count. If so, the active ID is not reused. Otherwise, the active ID is reused.

Blocks edges are typically reconstructed with less accuracy than interior pixels. This can introduce an artificial edge between adjacent blocks resulting in visible “blocking” of the reconstructed video sequence as illustrated in FIG. 11. In FIG. 11, block A 1102 is adjacent to block B 1104 with an artificial edge 1106 separating the two blocks. De-blocking is a process that smoothes the edges of adjacent blocks. Edge de-blocking between two inter predicted adjacent blocks is needed when the two blocks are predicted from different pictures. Thus, this presents a similar problem of identifying pictures as for identifying the reference pictures for co-located blocks, described above. Furthermore, de-blocking may also be needed if the two blocks are predicted using the same picture.

The active ID as described herein may also be used in the de-blocking process to identify whether two adjacent macroblocks have the same reference picture by uniquely identifying blocks contained in inter predicted P slices as well as all types of inter predicted B slices. FIG. 12 is a flow diagram of one embodiment of a de-blocking method 1200 using reference picture active IDs. The method 1200 comprises a processing loop of blocks 1202-1210. At block 1204, the de-blocking method 1200 retrieves the reference picture active IDs for a pair of adjacent blocks. The de-blocking method 1200 determines if the adjacent blocks were predicted using the same reference pictures at block 1206. If so, no de-blocking is needed. Otherwise, at block 1208, the method 1200 de-blocks the edge between the adjacent blocks. Blocks 1202-1210 are repeated for all pairs of adjacent blocks within a decoded picture.

In practice, the methods described herein may constitute one or more programs made up of machine-executable instructions. Describing the method with reference to the flowchart in FIG. 2, 4-11 and 13 enables one skilled in the art to develop such programs, including such instructions to carry out the operations (acts) represented by logical blocks on suitably configured machines (the processor of the machine executing the instructions from machine-readable media). The machine-executable instructions may be written in a computer programming language or may be embodied in firmware logic or in hardware circuitry. If written in a programming language conforming to a recognized standard, such instructions can be executed on a variety of hardware platforms and for interface to a variety of operating systems. In addition, the present invention is not described with reference to any particular programming language. It will be appreciated that a variety of programming languages may be used to implement the teachings of the invention as described herein. Furthermore, it is common in the art to speak of software, in one form or another (e.g., program, procedure, process, application, module, logic . . . ), as taking an action or causing a result. Such expressions are merely a shorthand way of saying that execution of the software by a machine causes the processor of the machine to perform an action or produce a result. It will be further appreciated that more or fewer processes may be incorporated into the methods illustrated in the flow diagrams without departing from the scope of the invention and that no particular order is implied by the arrangement of blocks shown and described herein.

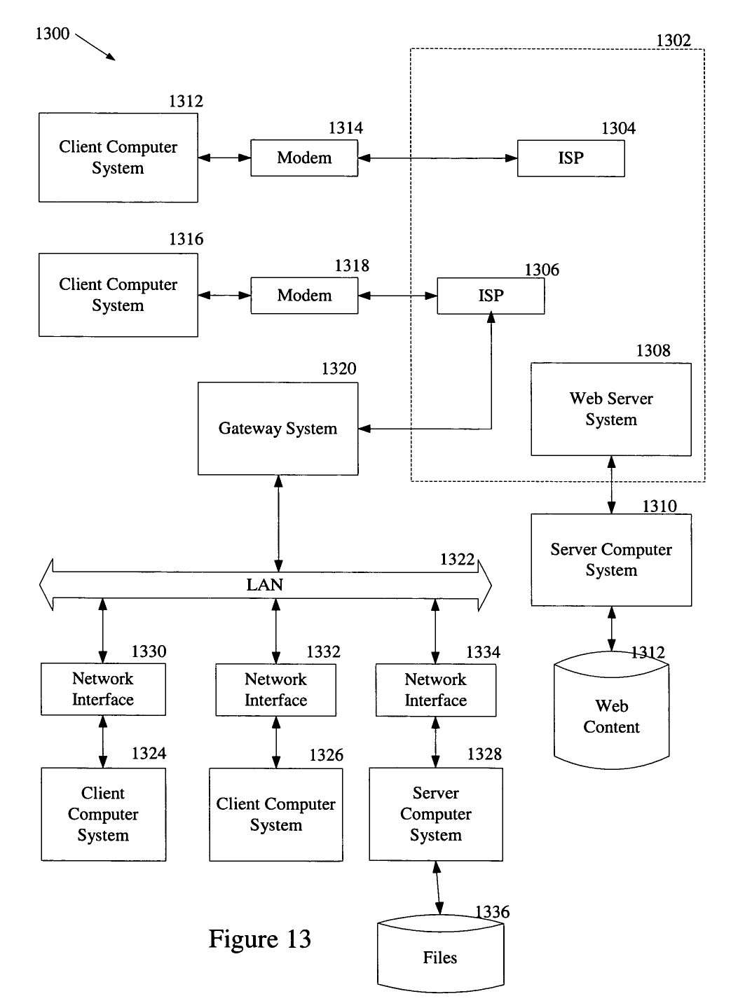

FIG. 13 shows several computer systems 1300 that are coupled together through a network 1302, such as the Internet. The term “Internet” as used herein refers to a network of networks which uses certain protocols, such as the TCP/IP protocol, and possibly other protocols such as the hypertext transfer protocol (HTTP) for hypertext markup language (HTML) documents that make up the World Wide Web (web). The physical connections of the Internet and the protocols and communication procedures of the Internet are well known to those of skill in the art. Access to the Internet 1302 is typically provided by Internet service providers (ISP), such as the ISPs 1304 and 1306. Users on client systems, such as client computer systems 1312, 1316, 1324, and 1326 obtain access to the Internet through the Internet service providers, such as ISPs 1304 and 1306. Access to the Internet allows users of the client computer systems to exchange information, receive and send e-mails, and view documents, such as documents which have been prepared in the HTML format. These documents are often provided by web servers, such as web server 1308 which is considered to be “on” the Internet. Often these web servers are provided by the ISPs, such as ISP 1304, although a computer system can be set up and connected to the Internet without that system being also an ISP as is well known in the art.

The web server 1308 is typically at least one computer system which operates as a server computer system and is configured to operate with the protocols of the World Wide Web and is coupled to the Internet. Optionally, the web server 1308 can be part of an ISP which provides access to the Internet for client systems. The web server 1308 is shown coupled to the server computer system 1310 which itself is coupled to web content 1312, which can be considered a form of a media database. It will be appreciated that while two computer systems 1308 and 1310 are shown in FIG. 13, the web server system 1308 and the server computer system 1310 can be one computer system having different software components providing the web server functionality and the server functionality provided by the server computer system 1310 which will be described further below.

Client computer systems 1312, 1316, 1324, and 1326 can each, with the appropriate web browsing software, view HTML pages provided by the web server 1308. The ISP 1304 provides Internet connectivity to the client computer system 1312 through the modem interface 1314 which can be considered part of the client computer system 1312. The client computer system can be a personal computer system, a network computer, a Web TV system, a handheld device, or other such computer system. Similarly, the ISP 1306 provides Internet connectivity for client systems 1316, 1324, and 1326, although as shown in FIG. 13, the connections are not the same for these three computer systems. Client computer system 1316 is coupled through a modem interface 1318 while client computer systems 1324 and 1326 are part of a LAN. While FIG. 13 shows the interfaces 1314 and 1318 as generically as a “modem,” it will be appreciated that each of these interfaces can be an analog modem, ISDN modem, cable modem, satellite transmission interface, or other interfaces for coupling a computer system to other computer systems. Client computer systems 1324 and 1316 are coupled to a LAN 1322 through network interfaces 1330 and 1332, which can be Ethernet network or other network interfaces. The LAN 1322 is also coupled to a gateway computer system 1320 which can provide firewall and other Internet related services for the local area network. This gateway computer system 1320 is coupled to the ISP 1306 to provide Internet connectivity to the client computer systems 1324 and 1326. The gateway computer system 1320 can be a conventional server computer system. Also, the web server system 1308 can be a conventional server computer system.

Alternatively, as well-known, a server computer system 1328 can be directly coupled to the LAN 1322 through a network interface 1334 to provide files 1336 and other services to the clients 1324, 1326, without the need to connect to the Internet through the gateway system 1320. Furthermore, any combination of client systems 1312, 1316, 1324, 1326 may be connected together in a peer-to-peer network using LAN 1322, Internet 1302 or a combination as a communications medium. Generally, a peer-to-peer network distributes data across a network of multiple machines for storage and retrieval without the use of a central server or servers. Thus, each peer network node may incorporate the functions of both the client and the server described above.

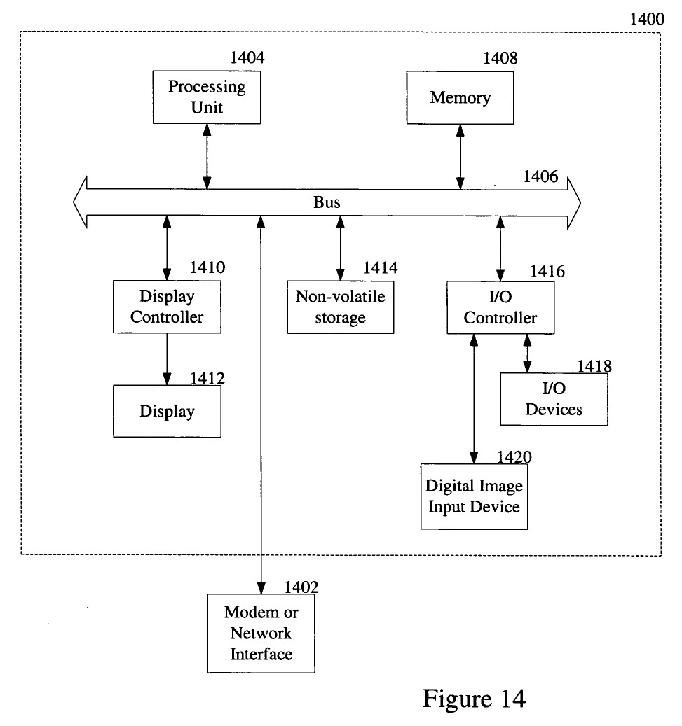

The following description of FIG. 14 is intended to provide an overview of computer hardware and other operating components suitable for performing the methods of the invention described above, but is not intended to limit the applicable environments. One of skill in the art will immediately appreciate that the embodiments of the invention can be practiced with other computer system configurations, including set-top boxes, hand-held devices, multiprocessor systems, microprocessor-based or programmable consumer electronics, network PCs, minicomputers, mainframe computers, and the like. The embodiments of the invention can also be practiced in distributed computing environments where tasks are performed by remote processing devices that are linked through a communications network, such as peer-to-peer network infrastructure.

FIG. 14 shows one example of a conventional computer system that can be used as encoder or a decoder. The computer system 1400 interfaces to external systems through the modem or network interface 1402. It will be appreciated that the modem or network interface 1402 can be considered to be part of the computer system 1400. This interface 1402 can be an analog modem, ISDN modem, cable modem, token ring interface, satellite transmission interface, or other interfaces for coupling a computer system to other computer systems. The computer system 1402 includes a processing unit 1404, which can be a conventional microprocessor such as an Intel Pentium microprocessor or Motorola Power PC microprocessor. Memory 1408 is coupled to the processor 1404 by a bus 1406. Memory 1408 can be dynamic random access memory (DRAM) and can also include static RAM (SRAM). The bus 1406 couples the processor 1404 to the memory 1408 and also to non-volatile storage 1414 and to display controller 1410 and to the input/output (I/O) controller 1416. The display controller 1410 controls in the conventional manner a display on a display device 1412 which can be a cathode ray tube (CRT) or liquid crystal display (LCD). The input/output devices 1418 can include a keyboard, disk drives, printers, a scanner, and other input and output devices, including a mouse or other pointing device. The display controller 1410 and the I/O controller 1416 can be implemented with conventional well known technology. A digital image input device 1420 can be a digital camera which is coupled to an I/O controller 1416 in order to allow images from the digital camera to be input into the computer system 1400. The non-volatile storage 1414 is often a magnetic hard disk, an optical disk, or another form of storage for large amounts of data. Some of this data is often written, by a direct memory access process, into memory 1408 during execution of software in the computer system 1400. One of skill in the art will immediately recognize that the terms “computer-readable medium” and “machine-readable medium” include any type of storage device that is accessible by the processor 1404 and also encompass a carrier wave that encodes a data signal.

Network computers are another type of computer system that can be used with the embodiments of the present invention. Network computers do not usually include a hard disk or other mass storage, and the executable programs are loaded from a network connection into the memory 1408 for execution by the processor 1404. A Web TV system, which is known in the art, is also considered to be a computer system according to the embodiments of the present invention, but it may lack some of the features shown in FIG. 14, such as certain input or output devices. A typical computer system will usually include at least a processor, memory, and a bus coupling the memory to the processor.

It will be appreciated that the computer system 1400 is one example of many possible computer systems, which have different architectures. For example, personal computers based on an Intel microprocessor often have multiple buses, one of which can be an input/output (I/O) bus for the peripherals and one that directly connects the processor 1404 and the memory 1408 (often referred to as a memory bus). The buses are connected together through bridge components that perform any necessary translation due to differing bus protocols.

It will also be appreciated that the computer system 1400 is controlled by operating system software, which includes a file management system, such as a disk operating system, which is part of the operating system software. One example of an operating system software with its associated file management system software is the family of operating systems known as Windows® from Microsoft Corporation of Redmond, Wash., and their associated file management systems. The file management system is typically stored in the non-volatile storage 1414 and causes the processor 1404 to execute the various acts required by the operating system to input and output data and to store data in memory, including storing files on the non-volatile storage 1414.

In the foregoing specification, the invention has been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

1. A computerized method comprising:
retrieving a frame buffer index and a frame-field mode of a decoded video picture; and
computing an active ID for the decoded video picture from the frame buffer index and the frame-field mode, the active ID uniquely identifying the corresponding decoded video picture.

2. The computerized method of claim 1, further comprising:
storing the active ID in a look-up table, wherein the look-up table associates the active ID with a reference ID and frame number of the decoded video picture.

3. The computerized method of claim 1, further comprising:
identifying the decoded video picture stored in a frame buffer using the corresponding active ID.

4. The computerized method of claim 3, wherein the decoded video picture identification by the active ID is used in a B direct temporal prediction process.

5. The computerized method of claim 3, wherein the decoded video picture identification by the active ID used in a de-blocking process.

6. The computerized method of claim 1, wherein computing the active ID for a frame of the decoded video picture comprises setting the active ID equal to the frame buffer index.

7. The computerized method of claim 1, wherein computing the active ID for a top field of the decoded video picture comprises setting the active ID equal to a value selected from a group consisting of a value equal to twice the frame buffer index and a value equal to the frame buffer index plus 16.

8. The computerized method of claim 1, wherein computing the active ID for a bottom field of the decoded video picture comprises setting the active ID equal to a value selected from a group consisting of a value equal to twice the frame buffer index plus one and a value equal to the frame buffer index plus 32.

9. The computerized method of claim 1, further comprising:
checking if the value of the active ID is reused.

10. The computerized method of claim 9, wherein checking if the value of the active ID is reused comprises comparing the decoded video picture frame number with frame numbers of a reference picture and a co-located picture.

11. The computerized method of claim 9, wherein checking if the value of the active ID is reused comprises comparing a co-located picture long term life count with a reference picture life count.

12. A computerized method comprising:
identifying a decoded video picture stored in a frame buffer by an associated active ID, the active ID computed from a frame buffer index and a frame-field mode of the decoded video picture and uniquely identifying the decoded video picture.

13. The computerized method of claim 12, wherein the decoded video picture identification by the active ID is used in a B direct temporal prediction process.

14. The computerized method of claim 12, wherein the decoded video picture identification by the active ID used in a de-blocking process.

15. A machine readable medium having executable instructions to cause a processor to perform a method comprising:
retrieving a frame buffer index and a frame-field mode of a decoded video picture; and
computing an active ID for the decoded video picture from the frame buffer index and the frame-field mode, the active ID uniquely identifying the corresponding decoded video picture.

16. The machine readable medium of claim 15, wherein the method further comprises:
storing the active ID in a look-up table, wherein the look-up table associates the active ID with a reference ID and frame number of the decoded video picture.

17. The machine readable medium of claim 15, wherein the method further comprises:
identifying the decoded video picture stored in a frame buffer using the corresponding active ID.

18. The machine readable medium of claim 17, wherein the decoded video picture identification by the active ID is used in a B direct temporal prediction process.

19. The machine readable medium of claim 17, wherein the decoded video picture identification by the active ID used in a de-blocking process.

20. The machine readable medium of claim 15, wherein computing the active ID for a frame of the decoded video picture comprises setting the active ID equal to the frame buffer index.

21. The machine readable medium of claim 15, wherein computing the active ID for a top field of the decoded video picture comprises setting the active ID equal to a value selected from a group consisting of a value equal to twice the frame buffer index and a value equal to the frame buffer index plus 16.

22. The machine readable medium of claim 15, wherein computing the active ID for a bottom field of the decoded video picture comprises setting the active ID equal to a value selected from a group consisting of a value equal to twice the frame buffer index plus one and a value equal to the frame buffer index plus 32.

23. The machine readable medium of claim 15, wherein the method further comprises:
checking if the value of the active ID is reused.

24. The machine readable medium of claim 23, wherein checking if the value of the active ID is reused comprises comparing the decoded video picture frame number with frame numbers of a reference picture and a co-located picture.

25. The machine readable medium of claim 23, wherein checking if the value of the active ID is reused comprises comparing a co-located picture long term life count with a reference picture life count.

26. A machine readable medium having executable instructions to cause a processor to perform a method comprising:
identifying a decoded video picture stored in a frame buffer by an associated active ID, the active ID computed from a frame buffer index and a frame-field mode of the decoded video picture and uniquely identifying the decoded video picture.

27. The machine readable medium of claim 26, wherein the decoded video picture identification by the active ID is used in a B direct temporal prediction process.

28. The machine readable medium of claim 26, wherein the decoded video picture identification by the active ID used in a de-blocking process.

29. An apparatus comprising:
means for retrieving a frame buffer index and a frame-field mode of a decoded video picture; and
means computing an active ID for the decoded video picture from the frame buffer index and the frame-field mode, the active ID uniquely identifying the corresponding decoded video picture.

30. The apparatus of claim 29, further comprising:
means for storing the active ID in a look-up table, wherein the look-up table associates the active ID with a reference ID and frame number of the decoded video picture.

31. The apparatus of claim 29, further comprising:
means for identifying the decoded video picture stored in a frame buffer using the corresponding active ID.

32. The apparatus of claim 29, wherein the means for computing the active ID for a frame of the decoded video picture comprises setting the active ID equal to the frame buffer index.

33. The apparatus of claim 29, wherein the means for computing the active ID for a top field of the decoded video picture comprises setting the active ID equal to a value selected from a group consisting of a value equal to twice the frame buffer index and a value equal to the frame buffer index plus 16.

34. The apparatus of claim 29, wherein the means for computing the active ID for a bottom field of the decoded video picture comprises setting the active ID equal to a value selected from a group consisting of a value equal to twice the frame buffer index plus one and a value equal to the frame buffer index plus 32.

35. The apparatus of claim 29, further comprising:
means for checking if the value of the active ID is reused.

36. An apparatus comprising:
means for identifying a decoded video picture stored in a frame buffer by an associated active ID, the active ID computed from a frame buffer index and a frame-field mode of the decoded video picture and uniquely identifying the decoded video picture; and
means for retrieving the decoded video picture.

37. A system comprising:
a processor;
a memory coupled to the processor though a bus; and
a process executed from the memory by the processor to cause the processor to retrieve a frame buffer index and a frame-field mode of a decoded video picture and compute an active ID for the decoded video picture from the frame buffer index, and the frame-field mode, the active ID uniquely identifying the corresponding decoded video picture.

38. The system of claim 37, wherein the process further causes the processor to store the active ID in a look-up table, wherein the look-up table associates the active ID with a reference ID and frame number of the decoded video picture.

39. The system of claim 37, wherein the process further causes the processor to identify the decoded video picture stored in a frame buffer using the corresponding active ID.

40. The system of claim 39, wherein the process to cause the processor to identify the decoded video picture by the active ID is used in a B direct temporal prediction process.

41. The system of claim 39, wherein the process to cause the processor to identify the decoded video picture by the active ID used in a de-blocking process.

42. The system of claim 37, wherein computing the active ID for a frame of the decoded video picture comprises setting the active ID equal to the frame buffer index.

43. The system of claim 37, wherein computing the active ID for a top field of the decoded video picture comprises setting the active ID equal to a value selected from a group consisting of a value equal to twice the frame buffer index and a value equal to the frame buffer index plus 16.

44. The system of claim 37, wherein computing the active ID for a bottom field of the decoded video picture comprises setting the active ID equal to a value selected from a group consisting of a value equal to twice the frame buffer index plus one and a value equal to the frame buffer index plus 32.

45. The system of claim 37, wherein the process further causes the processor to check if the value of the active ID is reused.

46. The system of claim 45, wherein checking if the value of the active ID is reused comprises comparing the decoded video picture frame number with frame numbers of a reference picture and a co-located picture.

47. The system of claim 45, wherein process causing the process to check if the value of the active ID is reused comprises comparing a co-located picture long term life count with a reference picture life count.

48. A system comprising:
a processor;
a memory coupled to the processor though a bus; and
a process executed from the memory by the processor to cause the processor to identify a decoded video picture stored in a frame buffer by an associated active ID, the active ID computed from a frame buffer index and a frame-field mode of the decoded video picture and uniquely identifying the decoded video picture.

49. The system of claim 48, wherein the process to cause the processor to identify the decoded video picture by the active ID is used in a B direct temporal prediction process.

50. The computerized method of claim 48, wherein the process to cause the processor to identify the decoded video picture by the active ID used in a de-blocking process.
